(19) United States
(12) Patent Application Publication
(10) Pub. No.: US 2025/0207898 A1
(43) Pub. Date: Jun. 26, 2025

(54) PROJECTILE TEST SYSTEM

(71) Applicant: The Charles Stark Draper Laboratory, Inc., Cambridge, MA (US)

(72) Inventors: Bryan TEECE, Cambridge, MA (US); Glenn R. THOREN, Cambridge, MA (US)

(73) Assignee: The Charles Stark Draper Laboratory, Inc., Cambridge, MA (US)

(21) Appl. No.: 18/989,607

(22) Filed: Dec. 20, 2024

Related U.S. Application Data
(60) Provisional application No. 63/613,499, filed on Dec. 21, 2023.

(51) Int. Cl. F42B 35/00

(52) U.S. Cl. CPC F42B 35/00

(57) ABSTRACT

Systems and methods for testing projectiles is disclosed. The system can include a projectile with one or more portions. Each portion can be rotatable about a major axis of the projectile. The projectile can include one or more sensors. The sensors can determine at least a relative position of the first portion to the second portion. The test system can include a radial centrifugal housing. The centrifugal housing can receive an intake of air, circulate the air radially around the major axis of the projectile, and rotate a first portion of the projectile at a first rate. The test system can include measurement unit to determine a condition of the projectile responsive to rotation of the first portion of the projectile.

### TECHNICAL FIELD

Aspects of the disclosure generally relate to systems and devices for testing projectiles.

### BACKGROUND

Projectiles in flight undergo a variety of strong forces, such as forces due to rotation and high acceleration. Aspects of projectiles can be damaged due to these high forces.

### SUMMARY

Presented herein are systems and methods to test a projectile. As a brief overview, the system can include a projectile, a radial centrifugal housing, and a measurement unit. The radial centrifugal housing can, through regulation by a controller and valves, provide air spinning at such a rate to rotate a portion of the projectile. The system can rotate the portion of the projectile at such a rate as to replicate an in-flight environment. This enables testing of various components of complex projectiles, such as sensor arrays, durability of the projectile and its components, and multiple spinning portions of the projectile, without losing the projectile to unrecoverable testing practices such as launch.

At least one aspect of the present disclosure is directed to a system for testing projectiles. The system can include a projectile. The projectile can include a first portion rotatable about a major axis of the projectile at a first rate. The projectile can include a second portion rotatable about the major axis of the projectile at a second rate different than the first rate. The projectile can include one or more sensor arrays disposed in the second portion. The one or more sensor arrays can determine at least a relative position of the first portion to the second portion. The system can include a radial centrifugal housing. The radial centrifugal housing can receive an intake of air. The radial centrifugal housing can circulate the air radially around the major axis of the projectile. The radial centrifugal housing can rotate the first portion of the projectile at the first rate. The first portion of the projectile can be disposed at least partially in the radial centrifugal housing. The system can include a measurement unit configured to determine a condition of the projectile responsive to rotation of the first portion of the projectile.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing and other objects, aspects, features, and advantages of the disclosure will become more apparent and better understood by referring to the following description taken in conjunction with the accompanying drawings. The accompanying drawings are not intended to be drawn to scale. Like reference numbers and designations in the various drawings indicate like elements. For purposes of clarity, not every component may be labeled in every drawing. In the drawings:

FIG. 1 illustrates a block diagram of a system for testing a projectile;

FIG. 2 illustrates a system for testing a projectile;

FIG. 3 illustrates a device for testing a projectile;

FIG. 4 illustrates an example system for testing a projectile;

FIG. 5 illustrates an intake to a centrifugal housing; and

FIGS. 6A and 6B illustrate a projectile which may be tested in the system for testing a projectile.

### DETAILED DESCRIPTION

Reference will now be made to the embodiments illustrated in the drawings, and specific language will be used here to describe the same. It will nevertheless be understood that no limitation of the scope of the disclosure is thereby intended. Alterations and further modifications of the features illustrated here, and additional applications of the principles as illustrated here, which would occur to a person skilled in the relevant art and having possession of this disclosure, are to be considered within the scope of the disclosure.

Described herein are systems and methods for testing projectiles. Projectiles, such as bullets, missiles, etc., undergo a variety of forces when in flight. Projectiles can be subject to forces which cause acceleration or deceleration in multiple axes, such as linearly and/or rotationally. Some projectiles can be multi-body projectiles in which one or more portions of the projectile move or rotate differently than another portion of the same projectile. Testing projectiles can be cumbersome due to the difficulties associated with generating forces extreme enough in a test environment to adequately simulate an empirical environment. Testing multi-body projectiles can pose difficulties due to generation of multiple extreme test forces to impinge upon the multi-body projectile in order to adequately simulate an empirical environment. As such, there does not currently exist a method to test multi-body projectiles with high rotation rates while they are in a test and production environment.

To account for these and other technical problems, the systems and devices presented herein enable testing of various portions of these projectiles at multiple different high rotation rates and forces that they would encounter during real operation (e.g., an empirical environment). The system can include a centrifugal housing, and one or more sensors or arrays of sensors. The system can include an air-flow regulator and a controller. A test subject (i.e., a multi-body projectile capable of achieving high rotation rates) can be mounted in the centrifugal housing. The centrifugal housing can receive an intake of air controlled, in some cases, by a controller. The centrifugal housing can circulate the air over the test subject to cause at least one portion of the test subject such as a rearward body or forward body to rotate. The systems and methods described herein can generate rates of rotation These substantially similar to the rates of rotation the test subject would experience during operation. As the test subject rotates, the sensor arrays can detect the relative position of the test subject, such as a relative position of the test subject within the centrifugal housing or a relative position of a portion of the test subject in relation to another portion of the test subject or the centrifugal housing. In some cases, the controller can regulate the intake of air to the centrifugal housing based on the relative position to modulate the rotational velocity of the test subject.

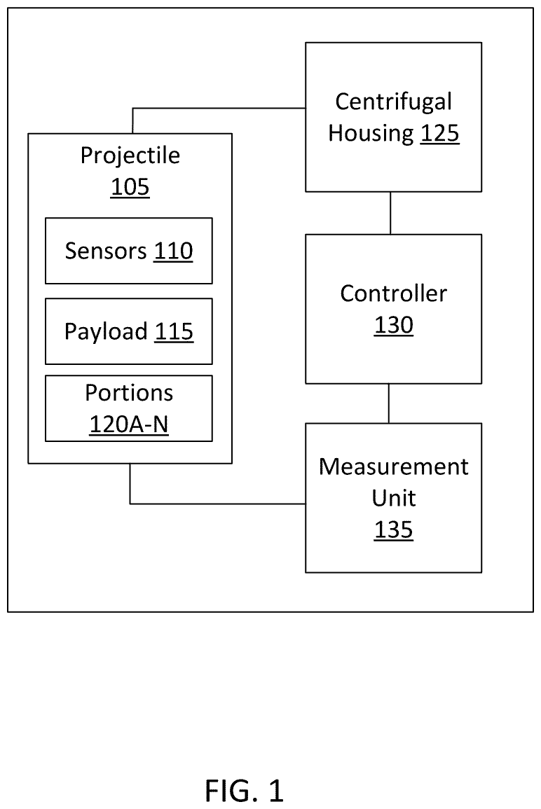

FIG. 1 depicts a block diagram of a system 100 for testing a projectile. The system can include a radial centrifugal housing 125 (also referred to herein as the “centrifugal housing 125”), a controller 130, a measurement unit 135, and a projectile 105. The projectile 105 can include at least sensors 110, a payload 115, and one or more portions 120A-N (also referred to herein as the “portion(s) 120”). In brief overview of the system 100, at least one portion 120A of the projectile 105 can be disposed within the centrifugal housing 125. The centrifugal housing 125 can be coupled with the controller 130. The controller 130 can control an intake of air to the centrifugal housing 125. The centrifugal housing 125 can receive the intake of air and can cause the air to spin radially about the portion 120A of the projectile within the centrifugal housing 125. The measurement unit 135 and the sensors 110 can provide information about the performance of the projectile 105 under test and conditions of the testing environment (e.g., within the centrifugal housing 125 or an enclosure surrounding the system 100). Embodiments may comprise additional or alternative components or omit certain components from those of FIG. 1, and still fall within the scope of this disclosure.

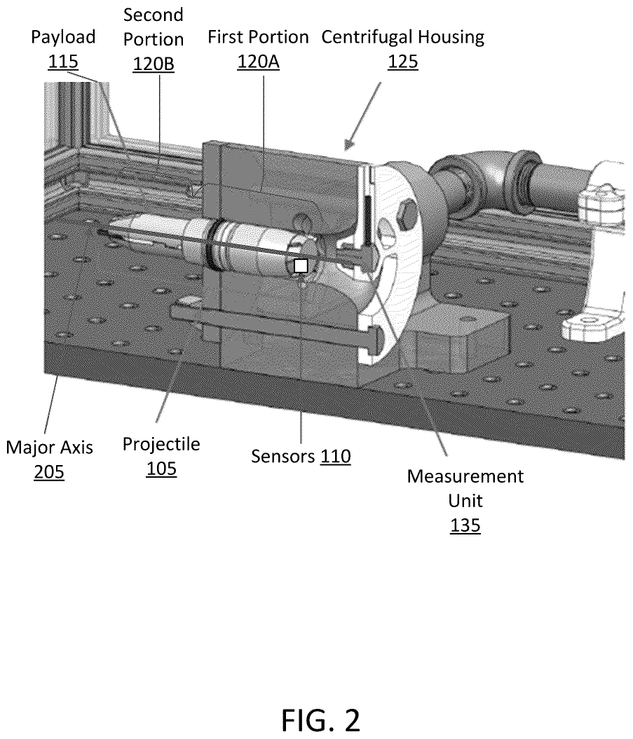

FIG. 2 illustrates a system 200 for testing a projectile. The system 200 can be an example of the system 100 and can include the components described with reference to FIG. 1, such as the centrifugal housing 125, the controller 130 (not pictured in FIG. 2), the measurement unit 135, and the projectile 105 and its components, the sensors 110, the payload 115, and the one or more portions 120A-N. The projectile 105 can include a major axis 205. As depicted in FIG. 2, the portion 120A can be referred to herein as the first portion 120A and a portion 120B can be referred to herein as the second portion 120B. The projectile 105 can include more or less portions 120 than the two portions 120A and 120B as expressed in FIG. 2.

The projectile 105 can be or include any type of projectile which may undergo high (e.g., more than 50,000 rpm) rotation. The projectile can include missiles, bullets, arrows, or other such devices which may be expelled from a chamber or otherwise propelled through a medium such as air, water, or space.

The projectile 105 can have the major axis 205. The major axis 205 can be the axis about which the projectile 105 rotates while in operation, such as flight. In some cases, the major axis 205 is the axis which extends parallel to the longest dimension of the projectile 105. In some cases, the major axis 205 is determined by the center of gravity of the projectile 105 and a direction of travel of the projectile 105. In some cases, the major axis 205 extends through each portion 120 of the projectile 105.

The projectile 105 can vary in dimensions. In some cases, the projectile 105 can be between 0.2-160 mm in diameter or width (e.g., as measured along an axis perpendicular to the major axis 205). For example, the projectile 105 can be between 15-60 mm in diameter. For example, the projectile 105 can be between 5 mm and 160 mm in diameter. It can be appreciated that the projectile 105 can vary in diameter and the systems described herein can be adapted to larger or smaller diameters of projectile 105.

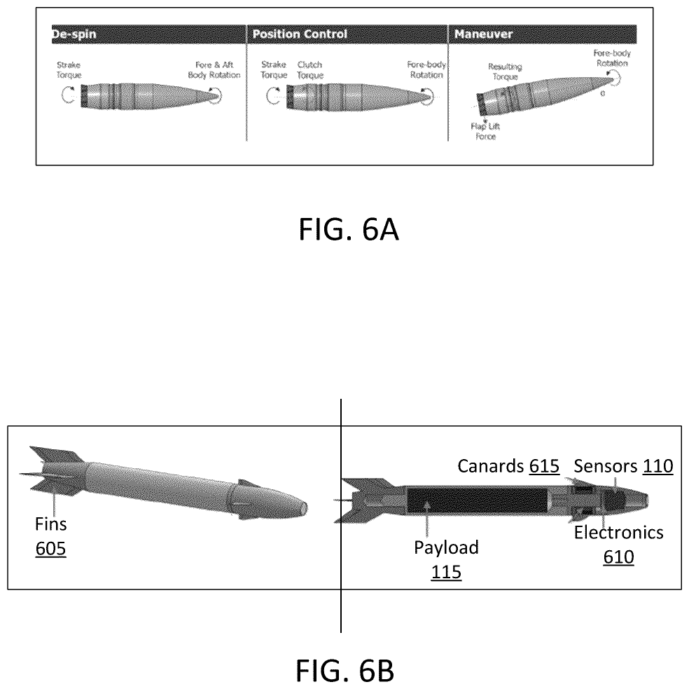

The projectile 105 can have the payload 115. The payload 115 can be any cargo, auxiliary systems, or other additional weight carried by the projectile 105. Further description and optional aspects of the projectile 105 can be seen with reference to FIG. 6.

The projectile 105 can be a multi-body projectile. For example, the projectile 105 can include the first portion 120A and the second portion 120B. Multi-body projectiles can be any partially or fully assembled, two-body projectile that operates at high rotation. For example, the projectile 105 can be a 20 mm projectile that exits a chamber at over 100 krpm or achieves 100 krpm during flight.

The portions 120 can rotate. The portions 120 can rotate about the major axis 205. Each portion of the portions 120 can rotate independently of the other. The portions 120 can exhibit different or overlapping rotational velocities. Here, “rotational velocity” can refer to both a magnitude and direction of the rotation. For example, the first portion 120A can rotate clockwise and the second portion 120B can rotate counter-clockwise. For example, each of the portions 120A and 120B can rotate counter-clockwise or clockwise. Each portion of the portions 120 can rotate at a different rotational rate (i.e., magnitude) than each other. For example, the first portion 120A can rotate at 30,000 rpm and the second portion 120B can rotate at 100,000 rpm. In some cases, a portion of the portion 120 may not rotate. For example, the first portion 120A may rotate at 60,000 rpm and the second portion 120B may not rotate (i.e., 0 rpm). In some cases, the portions 120 can each have different rates and directions, overlapping rates or directions, or a combination thereof.

The portions 120 can change rotational velocities independently of each other. In some cases, the first portion 120A can decelerate as the second portion 120B accelerates, or vice versa. In some cases, a portion of the portions 120 can decelerate to the point of 0 rpm. In some cases, a portion of the portions 120 can decelerate to the point of reversing direction. For example, the first portion 120 can have a first rotational velocity of 80,000 rpm clockwise and can decelerate to 20,000 rpm counter-clockwise.

In some cases, the first portion 120A can be considered a tail, aft, or rear portion. In some cases, the second portion 120B can be considered a forward or front portion.

One or more of the portions 120 can include the sensors 110. For example, the sensors 110 can be coupled to the second portion 120B. The sensors 110 can be or include any configuration of sensors, such as sensor arrays or sensor systems. The sensors 110 can be or include hall effect sensors, optical sensors, a generator with an asymmetrical coil or magnet which will give a signal to the projectile 105, coil sensing where each coil is individually sensed and counted, or optical sensing of a surface with a pattern, or any other sensor capable of object located external to a projectile and located a distance from the projectile 105. Circuitry or electronics (not pictured) coupled with the projectile 105 can be used to gather output from the signal and that output can either be processed onboard the projectile 105 or transmitted to an external device for processing. In some instances, the information is both processed onboard and sent to an external device for processing.

The sensors 110 can determine qualities of the projectile 105 or the environment in which the projectile 105 is operating, such as the centrifugal housing 125. In some cases, one or more of the sensors 110 can determine a rotational power of the projectile 105 or any of its portions 120. In some cases, one or more of the sensors 110 can determine rotational dynamics of the projectile 105, such as a rotational acceleration of the projectile 105 or any of its portions 120, a torque of the projectile 105 or any of its portions 120, a periodicity of rotation of the projectile 105 or any of its portions 120, among others.

At least one of the sensors 110 can identify a relative position of the projectile 105. In some cases, one or more of the sensors 110 can determine a position of the projectile 105 relative to the major axis 205, such as a rotational position of the projectile 105 or its portions 120. For example, one or more of the sensors 110 (e.g., an array of the sensors 110) can determine an angular displacement or rotational position of the projectile 105 or one or more of its portions 120 respective to the major axis. In some cases, one or more of the sensors 110 can identify or determine a position of one or more of the portions 120 respective to another of the one or more portions 120. For example, the sensors 110 can determine a position of the first portion 120A relative to a position of the second portion 120B.

In some cases, relative location information of the projectile 105 can enable guidance of the projectile 105 through an environment. For example, the relative location of one or more portions 120 can position the projectile 105 or any of its components (as described with reference to FIG. 6) to maneuver towards a detection or designation. For example, a sensor of the sensors 110 in the second portion 120B can aid with autonomous guidance of the projectile 105. In some cases, the sensor information from the sensor(s) 110 can provide for autonomous guidance of the projectile.

The sensors 110 can determine a position of the projectile 105 or its portion prior to, during, or after any rotation of the projectile 105 and/or its portions 120. The sensors 110 can be used to determine the relative position of moving or stationary portions 120 with respect to each other or with respect to an external object at any moment of time. In the case of a multi-body projectile that has more than one portion 120 spinning about the major axis 205, at least one sensor of the sensors 110 can detect the relative position of the portions 120 spinning about the major axis 205. For example, the projectile 105 with the first portion 120A and the second portion 120B, the second portion 120B can include at least a sensor 110 that can detect the direction of an object exterior to the portion 120B and compare that sensor input of the second portion 120B with the true position of the second portion 120B at any instant of time. In some cases, at least one sensor of the sensors 110 can be included in the first or forward body of a multi-body projectile (i.e., the second portion 120B of the projectile 105), and the sensor can detect an object that located in a direction that is not on the current trajectory of the projectile. That information can be used to activate a maneuvering system on the projectile 105, such as on the first portion 120A, to execute a maneuver to place the detected object on the trajectory of the projectile 105.

The centrifugal housing 125 can be or include any housing capable of providing a radial airflow around the major axis 205 to at least one portion 120 of the projectile 105. The centrifugal housing 125 can accept, receive, or take in a fluid, such as ambient air or water. In some cases, an intake of air can be from compressed air, ambient air, vacuum-forced, etc. The intake of air can include any composition of air, such as at any atmospheric level or various humidities, among others. In some cases, the system 100, 200, can be adapted for testing projectile 105 in low air, outer space, or aqueous environments, among others.

At least one portion of the portions 120 can be disposed, at least partially in the centrifugal housing 125. The centrifugal housing 125, in addition to the other components of the system 100, 200, can flow air at high velocities across the projectile 105 or its subcomponents. The centrifugal housing 125 can cause one or more of the portions 120 to rotate in a manner similar to in a real operable environment, e.g. projecting through air/the sky. For example, the centrifugal housing 125 can cause the first portion 120A and the second portion 120B to rotate simultaneously at the same or different rates or directions. The centrifugal housing 125 can cause any of the portions 120 to begin, slow, speed up, or stop rotation. In some cases, the centrifugal housing 125 can include a clamp to hold one or more of the portions 120 stationary.

The system 100, 200 can include the measurement unit 135. The measurement unit 135 can be or include any sensors, meters, or detectors which provide information about the testing of the projectile 105 externally to the projectile 105. For example, the measurement unit 135 can be a tachometer to measure a rate of the rotating projectile 105 or its portions 120. For example, the measurement unit 135 can be or include an optical sensor, such as a camera, for recording images of the rotating projectile 105 or its portions 120.

The measurement unit 135 can determine a condition of the projectile 105 responsive to rotation of the first portion 120A of the projectile 105. The condition can include a wear of the projectile 105. The wear of the projectile 105 can refer to a decay in any of the components of the projectile 105 resulting from usage or testing of the projectile 105. The condition can include a tolerance of the projectile, such as in spacing, power usage, or other measurable quantities of the projectile 105 subject to tolerances. The condition can include power generation of the projectile, such as generated by two or more rotating portions 120. The condition can include friction forces of the projectile, such as exerted on the projectile 105 by the centrifugal housing 125. The condition can include a speed of rotation of the projectile 105.

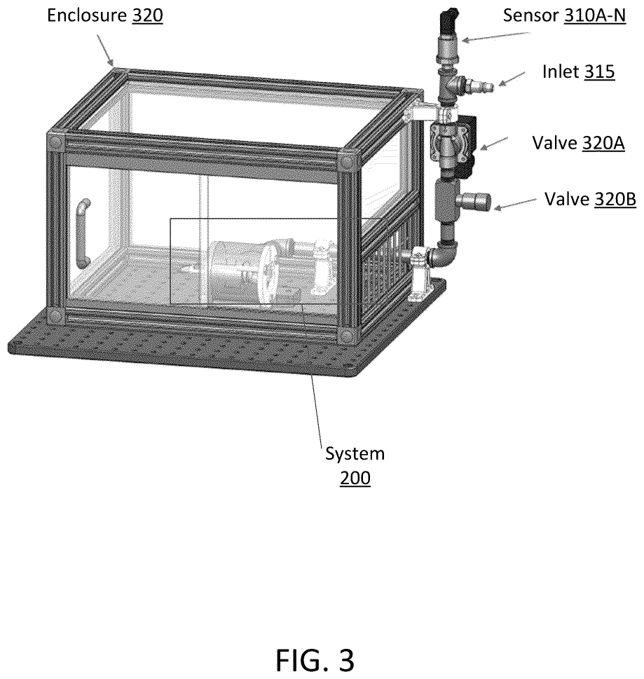

The centrifugal housing 125 can include or be coupled with various valves 320A-N, other sensors 310A-N, and inlet 315 as shown in FIG. 3. FIG. 3 illustrates a device for testing a projectile, such as the projectile 105. The valves 320A-N can control the intake of air to the centrifugal housing 125. The valves 320A-N can include an on/off valve, a needle valve, a pressure valve, among others. The inlet 315 can couple with a pressurized gas tank, or take in air from the ambient environment, among others. The sensors 310A-N can include pressure sensors, among others, to regulate the intake of air to the centrifugal housing 125. In some cases, the centrifugal housing 125 can be coupled with the controller 130 to control the intake of air to the centrifugal housing 125. For example, the controller 130 can regulate a quantity, pressure, or rate of air into the centrifugal housing 125 by manipulating or actuating the sensor 310A-N, inlet 315, or valves 320A-N.

The components of the system 100 can flow air at high velocities across the subcomponents of the projectile 105 to spin the rearward body (e.g., the first portion 120A) at rotation rates as if it were in its real-world environment. The measurement unit 135 and/or the sensors 310A-N can be coupled to the controller 130 to regulate air and thus the rotational velocity of the projectile 105. This can be a closed loop or open loop system. For example, the controller can modify a quantity of air supplied to the centrifugal housing 125 to change a velocity of rotation of the portion 120A responsive to one or more readings from the sensors 110 or the measurement unit 135.

The system 100, 200 can be enclosed in a housing or enclosure, such as the enclosure 320. In some cases, the enclosure 320 is transparent to enable viewing of the test projectile 105. In some cases, the enclosure 320 is hermetically sealed, vacuum sealed, or otherwise sealed from an external environment. In some cases, the enclosure 320 can include a door, window, or other opening to access the system 200 therein.

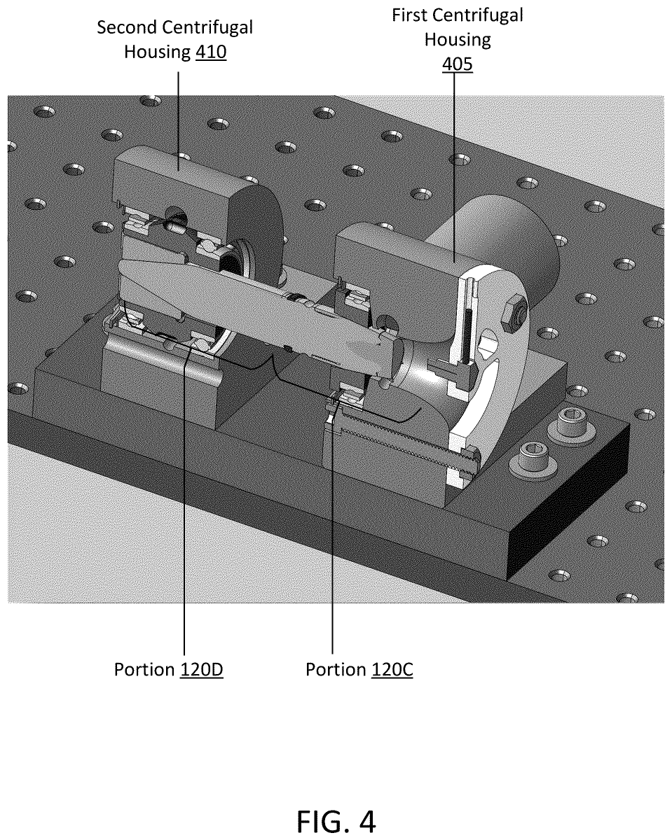

Turning now to FIG. 4, the system 100, 200 can be expanded to the system 400 by way of additional centrifugal housings 405 and 410. FIG. 4 depicts an example system 400 in which there are two centrifugal housings 405 and 410. The first centrifugal housing 405 and the second centrifugal housing 410 can be like or have any of the functionalities of the centrifugal housing 125. In some cases, a portion 120C of a projectile (such as the projectile 105) can be disposed in the first centrifugal housing 405. In some cases, a portion 120D of the projectile can be disposed in the second centrifugal housing 410. Though the portions 120C and 120D are shown as adjacent to each other in FIG. 4, it should be understood that each portion disposed within a centrifugal housing need not be adjacent to another disposed portion and that portions of the projectile may not be enclosed in any centrifugal housing.

In some cases, the centrifugal housings 405, 410 can receive separate intakes of air, or the same intake of air. In some cases, the centrifugal housings 405, 410 can be coupled with a same set of valves, some overlapping valves, or no overlapping valves. For example, the second centrifugal housing 410 can receive a second intake of air. The second centrifugal housing 410 can circulate the second air radially around the major axis of the projectile, such as the major axis 205 of the projectile 105. The first centrifugal housing 405 can receive a first intake of air. The first centrifugal housing 405 can circulate the first air radially around the major axis of the projectile, such as the major axis 205 of the projectile 105. In some cases, the first centrifugal housing 405 can circulate the first air to cause the portion 120C to rotate at a first rate. In some cases, the second centrifugal housing 410 can circulate the second air to cause the portion 120D to rotate at a second rate. In some cases, the first rate and the second rate are the same. In some cases, the first rate and the second rate are different. In some cases, the portion 120D is rotated in a different direction than the portion 120C. In some cases, the portion 120D is rotated in the same direction as the portion 120C.

The second radial centrifugal housing 410 can at least partially concurrently rotate the second portion 120D. For example, the second radial housing 410 can rotate the portion 120D for an overlapping duration of time as the first centrifugal housing 405 rotates the portion 120C. The second radial centrifugal housing 410 can at least partially concurrently rotate the second portion 120D based on the relative position of the first portion 120C to the second portion 120D.

The radial centrifugal housing can rotate any of the portions 120 at a rate and direction. In some cases, the centrifugal housing can rotate the portion 120 at a rate of between 40,000-150,000 rpm. In some cases, the centrifugal housing can rotate the portion 120 between 0-40,000 rpm. In some cases, the centrifugal housing can rotate the portion 120 at a rate between 100,000-200,000 rpm.

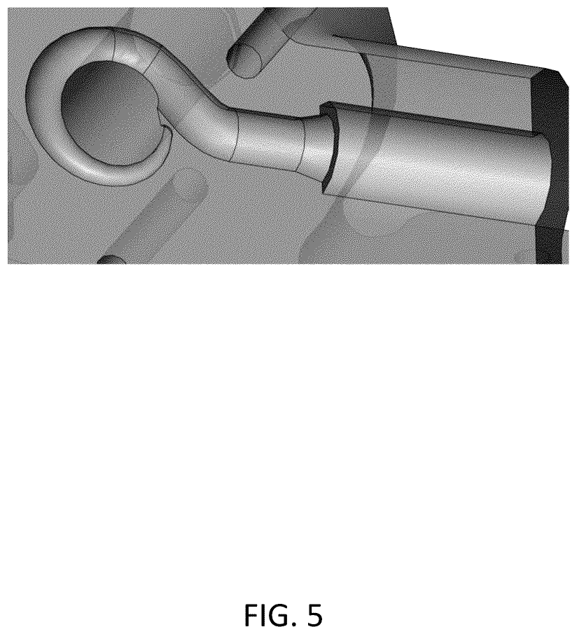

Turning now to FIG. 5, depicted is an intake 500 to a centrifugal housing, such as the centrifugal housing 125. The centrifugal housing 125 can be coupled to an air input such as the intake 500. The intake 500 can be a tapered air input to provide the intake of air to the radial centrifugal housing. In some cases, the tapered air input has a first inner diameter of 0.25-1.00 inches tapering to a second inner diameter of 0.05-0.24 inches. This range is meant to be non-limiting, as a tapered air input can vary in dimension. In some cases, at least a section of the intake 500 can be curved. In some cases, the intake 500 can be curved by at least 270 degrees. In some cases, the intake 500 can be curved by at least 300 degrees.

FIGS. 6A and 6B illustrate a projectile which may be tested in the system for testing a projectile. The system 100 can be used to test various components and maneuvers of the projectile 105. For example, the system 100 can test that various components of the projectile 105 are capable of operating to produce desired maneuvers such as de-spinning, position control, and maneuvering, as shown in FIG. 6A. FIG. 6B depicts the projectile 105. The projectile 105 can include components such as the sensors 110, fins 605, the payload 115, various electronics 610, and canards 615. The various components of the projectile 105 can aid the projectile in flight, navigation, tracking, seeking, or other maneuvers of the projectile 105.

The sensors 110 of the projectile 105 can include seeker sensors, such as an infrared (e.g., long-wave infrared (LWAR)), ultrasonic, LIDAR, or other such sensors. In some instances, a projectile fitted with a seeker sensor can be used in a fire and forget scenario where the projectile is substantially self-guided. Information observed prior to firing the projectile, together with onboard sensor data can be used to autonomously guide the projectile. In particular, the projectile's on-board targeting sensor, or seeker, can autonomously detect/track a target, compute the updated guidance solution, maneuver for precision in reaching the target. In some instances, this can include a long-wave infra-red (LWIR) and a radio frequency (RF) seeker.

The canards 615 can be like or include a flap, wing, fin, or other device intended to aid the projectile 105 in movement. In some cases, the canards can be canted canards or divert flaps. The canards 125 can generate a resultant torque on the projectile 105 during testing, flight, or other fluid flow over the projectile 105 to influence to projectile's trajectory.

The projectile 105 can include the fins 605. In some cases, the fins 605 are located on a portion of the projectile 105, such as the first portion 120A. In some cases, the fins 605 can deploy, turn, or otherwise move responsive to a detected rotation of the projectile 105 by the sensors 110. In some cases, the fins 605 can impart a force on the projectile 105 that induces an angle of descent that produces an adjustable lateral acceleration maneuver.

The systems and devices described herein can thereby solved the technical problem of testing multi-body projectiles at high rotation rates. The systems and devices described herein allow for applications of various rotation rates and directions at speeds which mimic the real-flight environment of the projectile. In this manner, complex subsystems for maneuvering, sensing, and other functionalities can be tested on a multibody projectile without performing an experimental launch.

What is claimed is:

1. A system for testing a projectile, comprising:
a projectile comprising:
a first portion rotatable about a major axis of the projectile at a first rate;
a second portion rotatable about the major axis of the projectile at a second rate different than the first rate; and
one or more sensor arrays disposed in the second portion and configured to determine at least a relative position of the first portion to the second portion;
a radial centrifugal housing configured to:
receive an intake of air;
circulate the air radially around the major axis of the projectile; and
rotate the first portion of the projectile at the first rate,
wherein the first portion of the projectile is disposed at least partially in the radial centrifugal housing; and
a measurement unit configured to determine a condition of the projectile responsive to rotation of the first portion of the projectile.

2. The system of claim 1, wherein a second radial centrifugal housing is configured to:
receive a second intake of air;
circulate the second air radially around the major axis of the projectile; and
rotate the second portion of the projectile at the second rate, wherein the second rate opposes the first rate.

3. The system of claim 2, wherein the second radial centrifugal housing is configured to at least partially concurrently rotate the second portion.

4. The system of claim 3, wherein the second radial centrifugal housing is configured to at least partially concurrently rotate the second portion based on the relative position of the first portion to the second portion.

5. The system of claim 1, wherein the radial centrifugal housing is coupled to a tapered air input to provide the intake of air to the radial centrifugal housing.

6. The system of claim 5, wherein the tapered air input has a first inner diameter of 0.25-1.00 inches tapering to a second inner diameter of 0.05-0.24 inches.

7. The system of claim 1, wherein the tapered air input is coupled to an inlet of the radial centrifugal housing and wherein a section of the tapered air input coupled to the inlet of the radial centrifugal housing is curved at least 270 degrees.

8. The system of claim 1, wherein the radial centrifugal housing is configured to rotate the first portion at a rate of between 10,000-225,000 rpm.

9. The system of claim 1, comprising a clamp configured to hold the second portion of the projectile stationary during the circulation of the air.

10. The system of claim 1, wherein the projectile is between 6-160 mm in diameter.

11. The system of claim 1, wherein the condition is one of a wear of the projectile, a tolerance of the projectile, power generation of the projectile, friction forces of the projectile, or a speed of rotation of the projectile.

12. The system of claim 1, wherein at least the projectile and the housing are arranged within a transparent enclosure.

13. An enclosure for testing a projectile, comprising:
a projectile comprising:
a first portion rotatable about a major axis of the projectile at a first rate;
a second portion rotatable about the major axis of the projectile at a second rate different than the first rate; and
one or more sensor arrays disposed in the second portion and configured to determine at least a relative position of the first portion to the second portion;
a radial centrifugal housing configured to:
receive an intake of air;
circulate the air radially around the major axis of the projectile; and
rotate the first portion of the projectile at the first rate,
wherein the first portion of the projectile is disposed at least partially in the radial centrifugal housing; and
a measurement unit configured to determine a condition of the projectile responsive to rotation of the first portion of the projectile.

14. The device of claim 13, wherein a second radial centrifugal housing is configured to:
receive a second intake of air;
circulate the second air radially around the major axis of the projectile; and
rotate the second portion of the projectile at the second rate, wherein the second rate opposes the first rate.

15. The device of claim 13, wherein the radial centrifugal housing is configured to at least partially concurrently rotate the second portion.

16. The device of claim 13, wherein the radial centrifugal housing is configured to at least partially concurrently rotate the second portion based on the relative position of the first portion to the second portion.

17. The device of claim 13, wherein the radial centrifugal housing is coupled to a tapered air input to provide the intake of air to the at least one radial centrifugal housing.

18. The device of claim 13, wherein the radial centrifugal housing is configured to rotate the first portion at a rate of between 40,000-150,000 rpm.

19. The system of claim 1, comprising a clamp configured to hold the second portion of the projectile stationary during the circulation of the air.

20. The system of claim 1, wherein the condition is one of a wear of the projectile, a tolerance of the projectile, power generation of the projectile, friction forces of the projectile, or a speed of rotation of the projectile.
